(19) United States
(12) Patent Application Publication
(10) Pub. No.: US 2021/0266255 A1
(43) Pub. Date: Aug. 26, 2021

(54) VRF SEGREGATION FOR SHARED SERVICES IN MULTI-FABRIC CLOUD NETWORKS

(71) Applicant: Cisco Technology, Inc., San Jose, CA (US)

(72) Inventors: Sivakumar Ganapathy, Fremont, CA (US); Saurabh Jain, Fremont, CA (US); Neelesh Kumar, Pleasanton, CA (US); Prashanth Matety, Fremont, CA (US); Hari Hara Prasad Muthulingam, Dublin, CA (US); Suresh Pasupula, Cupertino, CA (US)

(21) Appl. No.: 16/799,476

(22) Filed: Feb. 24, 2020

(51) Int. Cl. H04L 12/741; H04L 29/08; H04L 12/46

(52) U.S. Cl. CPC H04L 45/74; H04L 12/4633; H04L 12/4641; H04L 67/1002

(57) ABSTRACT

Techniques for maintaining virtual routing and forwarding (VRF) segregation for network paths through multi-cloud fabrics that utilize shared services, e.g., application load balancers. The router of a first network of a multi-cloud fabric receives a first data packet from a source end-point group within the first network and forwards the first data packet to a service end-point group. The service end-point group may forward the first data packet to a destination end-point group of a second network of the multi-cloud fabric. The service end-point group may receive a second data packet from the destination end-point group and forward the second data packet to the router. Based on one of (i) an identity of the service end-point group or (ii) an address of the source end-point group, a VRF may be identified and the second data packet may be forwarded by the router to the source end-point group using the VRF.

### TECHNICAL FIELD

The present disclosure relates generally to maintaining virtual routing and forwarding (VRF) segregation for network paths through multi-cloud fabrics that utilize shared services, e.g., application load balancers (ALBs).

### BACKGROUND

With the continued increase in the proliferation and use of devices with Internet accessibility, the demand for Internet services and content has similarly continued to increase. The providers of the Internet services and content continue to scale the computing resources required to service the growing number of user requests without falling short of user-performance expectations. For instance, providers typically utilize large and complex datacenters to manage the network and content demands from users. The datacenters generally comprise server farms that host workloads that support the services and content, and further include network devices such as switches and routers to route traffic through the datacenters and enforce security policies.

Generally, these networks of datacenters are one of two types: private networks owned by entities such as enterprises or organizations (e.g., on-premises networks); and public cloud networks owned by cloud providers that offer computing resources for purchase by users. Often, enterprises will own, maintain, and operate on-premises networks of computing resources to provide Internet services and/or content for users or customers. However, as noted above, it can become difficult to satisfy the increasing demands for computing resources while maintaining acceptable performance for users. Accordingly, private entities often purchase or otherwise subscribe for use of computing resources and services from public cloud providers. For example, cloud providers can create virtual private clouds (also referred to herein as “private virtual networks”) on the public cloud and connect the virtual private cloud or network to the on-premises network in order to grow the available computing resources and capabilities of the enterprise. Thus, enterprises can interconnect their private or on-premises network of datacenters with a remote, cloud-based datacenter hosted on a public cloud, and thereby extend their private network.

However, because on-premises networks and public cloud networks are generally developed and maintained by different entities, there is a lack of uniformity in the policy management and configuration parameters between the datacenters in the on-premises networks and public cloud networks. This lack of uniformity can significantly limit an enterprise's ability to integrate their on-premises networks with public cloud networks by, for example, being unable to apply consistent policies, configuration parameters, routing models, and so forth. Various entities have developed software-defined network (SDN) and datacenter management solutions that translate the intents of enterprise or organizations from their on-premises networks into their virtual private cloud networks for applications or services that are deployed across multi-cloud fabrics or environments. Accordingly, these multi-cloud SDN solutions must continually adapt for changes occurring within the on-premises networks and public cloud networks, while maintaining the business and user intents of the enterprises or organizations that supplement their on-premises networks with computing resources from the public cloud networks.

For example, enterprises that manage on-premises networks of datacenters often isolate and segment their on-premises networks to improve scalability, resiliency, and security in their on-premises networks. To satisfy the entities' desire for isolation and segmentation, the endpoints in the on-premises networks can be grouped into endpoint groupings (EPGs) using, for example, isolated virtual networks that can be used to containerize the endpoints to allow for applying individualized routing models, policy models, etc., across the endpoints in the EPGs. Generally, each subnet in an EPG or other virtual grouping of endpoints is associated with a range of addresses that can be defined in routing tables used to control the routing for the subnet. Due to the large number of routing tables implemented to route traffic through the on-premises networks, the entities managing the on-premises networks utilize virtual routing and forwarding (VRF) technology such that multiple instances of a VRF routing table are able to exist in a router and work simultaneously. Accordingly, subnets of EPGs in the on-premises networks of entities are associated with respective VRF routing tables and routers are able to store and utilize multiple instances of VRF routing tables simultaneously.

Services inserted into and/or between cloud networks, e.g., application load balancers (ALBs) in Amazon Web Services (AWS), distribute application traffic based on uniform resource locators (URLs) across web servers in AWS virtual private clouds (VPCs). However, the source of the traffic should come from a unique IP address since VRF segmentation is lost the moment a data packet enters the ALB. The loss of VRF segmentation while inserting services is unacceptable and at the same time, support is needed for traffic originating from overlapping subnets across multiple VRFs.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIGS. 1A and 1B illustrate a system diagram of an example architecture for maintaining isolation and segregation for network paths through multi-cloud fabrics that utilize VRF technologies.

FIGS. 2A-2C schematically illustrate an example data flow of packets in a multi-cloud fabric in which a service is inserted.

FIG. 3 illustrates a flow diagram of an example method for maintaining isolation and segregation for network paths through multi-cloud fabrics that utilize virtual routing and forwarding (VRF) technologies.

FIG. 4 illustrates a computing system diagram illustrating a configuration for a datacenter that can be utilized to implement aspects of the technologies disclosed herein.

FIG. 5 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes a method of maintaining virtual routing and forwarding (VRF) segregation for network paths through multi-cloud fabrics that utilize shared services, e.g., application load balancers (ALBs). Since the source address of a second data packet (which is associated with an original, first data packet) returning to a router is always the shared service, a mechanism is needed to identify the VRF of the second data packet. Thus, the method may include a router of a first network of a multi-cloud fabric that comprises two or more networks receiving a first data packet from a source end-point group within the first network. In configurations, the multi-cloud fabric may comprise one or more cloud networks as networks. Additionally, in configurations, the multi-cloud fabric may comprise one or more on-premises networks as networks. The router may forward the first data packet to a service end-point group. The service end-point group may forward the first data packet to a destination end-point group. The service end-point group may receive a second data packet from the destination end-point group and forward the second data packet to the router. Based on one of (i) an identity of the service end-point group or (ii) an address of the source end-point group, a virtual routing and forwarding instance (VRF) may be identified. Based at least in part on identifying the VRF, the second data packet may be forwarded by the router to the source end-point group using the VRF.

Additionally, the method may include creating an access list matching an address of the source end-point group and the address of the destination end-point group. The access list may be created upon receipt at the router of the first data packet from the source end-point group. Based on the access list matching the address of the source end-point group and the address of the destination end-point group, a route map may be created identifying the VRF. The method may also include matching, by the router, the address of the destination end-point group with the source end-point group. The matching may occur upon receipt at the router of the second data packet from the service end-point group. Based at least in part on matching the address of the destination end-point group with the source end-point group, the VRF may be identified. Based at least in part on identifying the VRF, the second data packet may be forwarded by the router to the source end-point group using the VRF.

In configurations, the service end-point group may be a first service end-point group. Thus, the method may additionally comprise providing a second service end-point group. In configurations, one or both of the first service end-point group or the second end-point group may be a service chain. In configurations, based on having a first service end-point group and a second end-point group, identifying the VRF may comprise identifying the VRF based on whether the router receives the second data packet from the first service end-point group or receives the second data packet from the second service end-point group. Additionally, the method may include determining if the second data packet came from a service chain and identifying the VRF based on the service of the service chain from which the second data packet was received.

Additionally, the techniques described herein may be performed by a system and/or device having non-transitory computer-readable media storing computer-executable instructions that, when executed by one or more processors, performs the method described above.

### Example Embodiments

As noted above, enterprises and other organizations may own, maintain, and operate on-premises networks of computing resources for users or customers, and also for supporting internal computing requirements for running their organizations. However, due to the difficulties in satisfying the increasing demands for computing resources while maintaining acceptable performance for users, these enterprises may otherwise subscribe for use of computing resources and services from public cloud providers. For example, cloud providers can create virtual private clouds (also referred to herein as “private virtual networks”) on the public cloud and connect the virtual private cloud or network to the on-premises network in order to grow the available computing resources and capabilities of the enterprise. Thus, enterprises can interconnect their private or on-premises network of datacenters with a remote, cloud-based datacenter hosted on a public cloud, and thereby extend their private network.

However, the lack of uniformity between on-premises networks and public cloud networks across various dimensions, such as policy management, configuration parameters, etc., may significantly limit an enterprise's ability to integrate their on-premises networks with public cloud networks by, for example, being unable to apply consistent policies, configuration parameters, routing models, and so forth. Various SDN solutions have been developed to translate the intents of enterprises or organizations from their on-premises networks into their virtual private cloud networks for applications or services that are deployed across multi-cloud fabrics or environments. For example, Cisco's software-defined network and datacenter management solution, the Application-Centric Infrastructure (ACI), provides a comprehensive solution for automated network connectivity, consistent policy management, and simplified operations for multi-cloud environments. The Cisco Cloud ACI solution allows enterprises to extend their on-premises networks into various public clouds, such as Amazon Web Services (AWS), Google Cloud, Microsoft Azure, and so forth. The Cisco Cloud ACI solution provides an architectural approach for interconnecting and managing multiple regions and/or sites, such as by defining inter-cloud policies, providing a scalable architecture with full fault-domain isolation and change-domain isolation, and ensuring that issues cannot cascade and bring down the entire distributed environment.

Various challenges arise for SDN solutions such as Cisco Cloud ACI when attempting to interconnect on-premises networks of datacenters with public cloud networks of datacenters. For example, cloud providers may impose different restrictions on networking configurations and policies, routing and policy models, and/or other restrictions for their public clouds. These restrictions may be different than the restrictions or permissions implemented by enterprises who have developed their on-premises networks of datacenters. However, to interconnect on-premises networks with public cloud networks, SDN solutions in the multi-cloud fabric space often have to reconcile those differences to seamlessly scale the on-premises networks across the public cloud networks.

As an example, VPCs in a public cloud network generally need to connect to routers in order to route traffic between the endpoints in the VPCs of the public cloud network and endpoints or other devices in the on-premises network. SDN solutions attempt to automate this connectivity between the on-premises networks and public cloud networks, such as by using solutions offered by providers of the public cloud networks. As an example, AWS provides a Transit Gateway (TGW) for use in automating this connectivity. Generally, the TGW, or just gateway, comprises a distributed router that connects to multiple VPCs. Rather than establishing VPN connections from each VPC to the router, the gateway is able to connect multiple VPCs to a single gateway, and also their on-premises networks to the single gateway. Attaching VPNs to each VPC is a cumbersome and costly task, and the transit gateway provides a single connection from on-premises networks to reach multiple VPCs in the AWS public cloud with relatively high bandwidth compared to VPN connections

While these gateways are advantageous for various reasons, the different restrictions imposed for using these gateways surface issues for SDN controllers to solve when automating interconnectivity across a multi-cloud fabric. As an example, the gateways may require that each VPC connected to a particular gateway do not have overlapping subnets. Stated otherwise, all of the VPCs connected to a given gateway may be required to have unique address spaces or ranges (e.g., classless inter-domain routing (CIDR) blocks) that do not overlap. However, enterprises that manage on-premises networks often define address ranges, such as VRFs, that have overlapping address spaces (e.g., overlapping prefixes). In fact, that is one of the advantages of VRFs is to allow for overlapping subnets while providing segmentation and isolation for network paths. Further, SDN solutions may employ routers that use tunnels to connect to the on-premises networks with network overlays such as virtual extensible local access network (VxLAN) that preserve the VRF information in packets in the multi-cloud fabric. However, the gateway provided by public cloud networks, such as AWS, may not support the overlay function to preserve the VRF information in data packets.

In configurations, a shared service may be inserted into one of the networks, e.g., AWS. Such a shared service may be in the form of, for example, an application load balancer (ALB). ALBs are a key component to load balance application layer (the seventh layer of the Open Systems Interconnection (OSI) model) traffic. In the ACI environment, ALBs are inserted as a service between two EPGs.

Generally, after an ALB receives a request, the ALB evaluates rules in priority order to determine which rule to apply to select the target group for a rule action. Routing is performed independently for each target group. In this case, source VRF segmentation details are lost when the traffic reaches the ALB. The ACI environment provides a method for policy driven service insertion, automation and provisioning of ALBs. When this automated provisioning is stretched between on-premises networks and cloud networks, or between two cloud sites, cloud restrictions may prevent the use of same source IP addresses in different VRFs.

Thus, in configurations, when a first data packet is sent from an on-premises network to a virtual router including cloud services routers (CSR) with a source address for the sending EPG and a destination address for the ALB, the ALB is treated as an EPG. The incoming first data packet also includes a destination address for the target destination EPG at a cloud network. The first data packet may then be sent from the ALB to the target destination EPG via the appropriate TGW.

However, when the first data packet returns from the destination EPG as a second data packet (e.g., the first data packet has been processed) to return to the on-premises network, the second data packet is sent with a destination address of the ALB. The ALB re-sources the second data packet based on the network address translation (NAT) rules and puts a destination address on the second data packet. All the second data packets have the same source address prior to entering the CSR, e.g., all the second data packets have a source address of the ALB. Since the next stop from the ALB is the CSR, when the second data packet enters the CSR, a mechanism is now needed to identify the VRF of the second packet and perform VxLAN encapsulation with the correct rewrite/target visual networking index (VNI).

Since the source address of the second data packet in the CSR is always the ALB, a mechanism is needed to identify the VRF of the second data packet. Thus, in configurations, when the first data packet is received by the CSR, a policy-based routing (PBR) rule is instituted on the CSR to set the VRF of the incoming first data packet based on the source and destination IP addresses. Accordingly, an access list is maintained that matches source and destination IP addresses of incoming packets from the on-premises network. A route map is maintained that identifies the VRF based on the incoming data packets' source IP address at the on-premises network.

When the CSR receives data packets, e.g., second data packets from the cloud network, from the ALB for routing back to the on-premises network, the route map may be utilized to identify the VRF based on the destination address of the second data packets, which was the source address of the first data packets. Once the VRF of the second data packets is identified, the second data packets may be forwarded to the on-premises network in one of two ways. The second data packets may be forwarded via the VRF using VxLAN encapsulation to automatically route the second data packets from the CSR to an on-premises spine of the on-premises network. Without the VxLAN encapsulation, a tunnel interface may be created per VRF between the cloud CSR and an on-premises network IP terminating device, from which the packet will directly head to the ACI leaf on that particular VRF to the original source end-point group EPG, e.g., the destination EPG of the second data packet.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

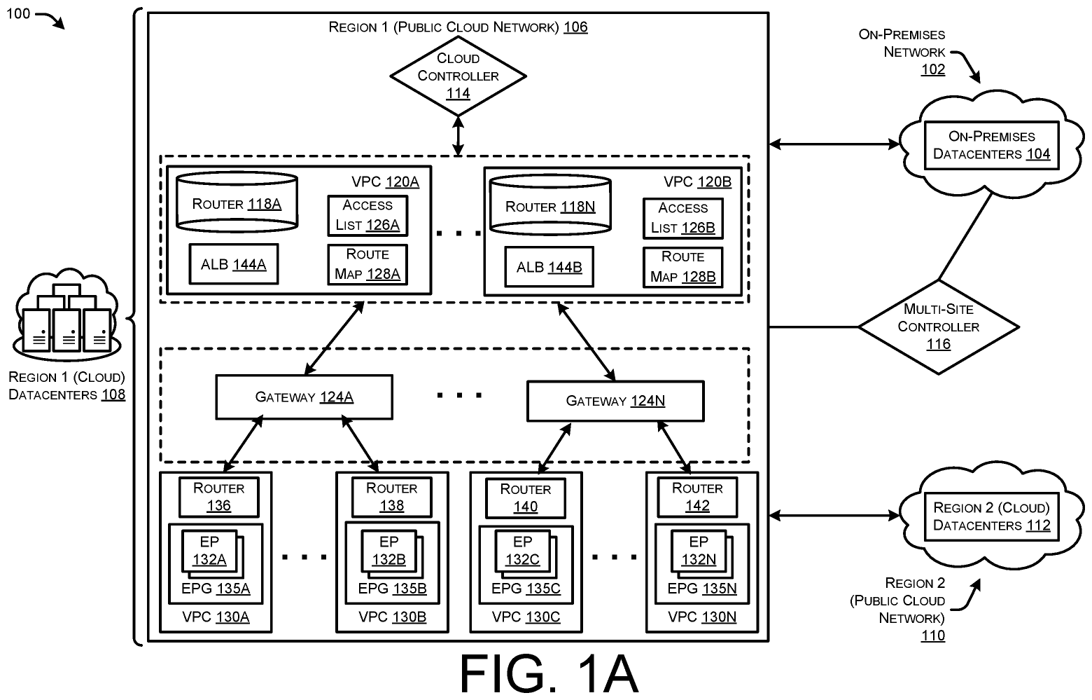

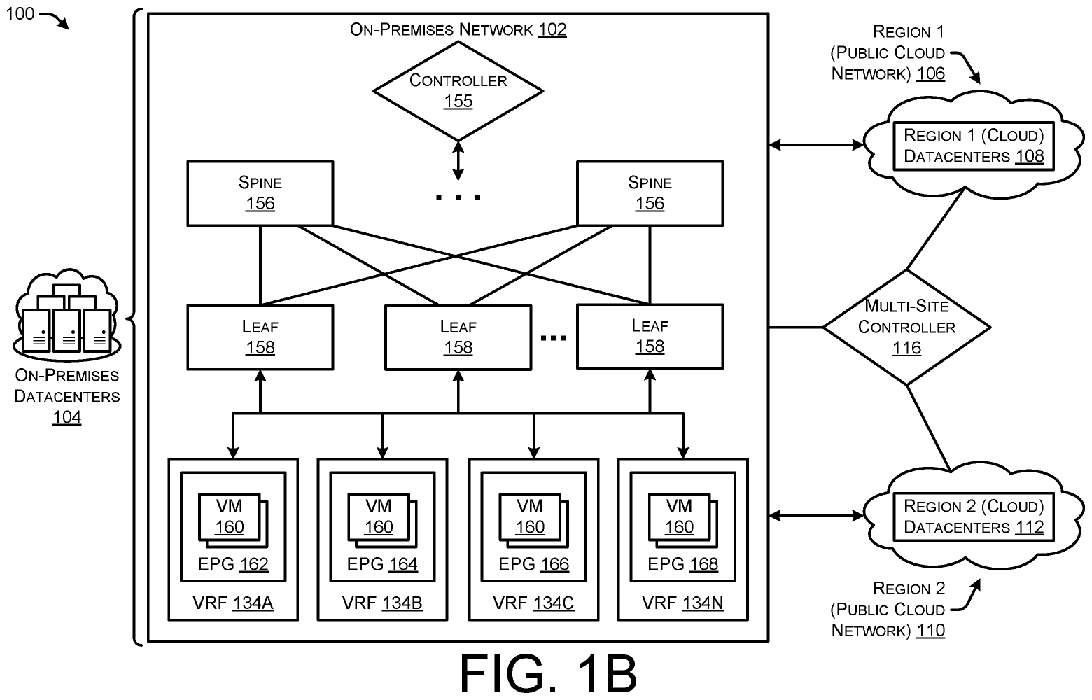

FIGS. 1A and 1B illustrate a system diagram of an example architecture for maintaining isolation and segregation for network paths through a multi-cloud fabric 100 that utilizes VRF technologies. In this example, the multi-cloud fabric 100 may include an on-premises network 102 comprised of one or more on-premises datacenters 104, public cloud networks 106 and 110 comprised of one or more cloud datacenters 108 and 112 (e.g., region 1 and region 2, respectively). The datacenters 104, 108, and 112 may comprise any type of datacenter housing endpoints (e.g., servers) for supporting workloads, virtual machines, containers, etc., as well as networking devices (e.g., switches, routers, gateways, etc.) for facilitating the communication of traffic in the networks 102, 106, and 110 according to specified routing models, security policies, and so forth. In configurations, the public cloud network 110 is configured in a manner at least similar to the public cloud network 106.

In this example, the on-premises network 102 may implement a specific SDN or datacenter solution, such as Cisco's ACI, while the public clouds 108 and 110 may implement different cloud solutions, such as Amazon's AWS, Microsoft's Azure, Google Cloud, and so forth. Generally, the security policies and network configurations of the networks 102, 106, and 110 can be managed by one or more controllers associated with the respective cloud provider, and/or an SDN controller for the multi-cloud solution, such as an ACI Application Policy Infrastructure Controller (APIC) and/or a multi-site APIC. APIC, and/or another SDN controller, is generally used to manage a site regardless of whether the site is on-premise 102 or a cloud network 106 and/or 110. The networking configurations and policies in public cloud networks 106 and 110 can have various routing and policy models or schemes, and different restrictions imposed by the cloud providers. For example, a cloud provider may impose restrictions which limit the number of security policies supported by an associated public cloud much below the scale of policies supported by the datacenter solution implemented at the on-premises datacenter 104. Accordingly, when Cisco's ACI solution is integrated with a public cloud solution, such as Amazon's AWS, the public cloud's restrictions can impose unnecessary restrictions on the ACI solution and create inconsistent policy models.

Accordingly, the multi-cloud fabric 100 can also include a multi-site controller 116 (e.g., multi-site APIC) which communicates with cloud controller 114 in the public cloud network 106 (e.g., cloud APIC), as well as controllers in the on-premises network 102 and the public cloud network 110. The multi-site controller 116 may work with the controllers to manage and implement policies and configurations on both the on-premises network 102 and the public cloud networks 106 and 110. The multi-site controller 116 can implement, such as by translating, a same policy model in the on-premises network 102 and the public cloud networks 106 and 110, which can be based on a particular SDN or datacenter solution such as Cisco's ACI. For example, the multi-site controller 116 can implement VRFs, EPGs and associated policies in the on-premises network 102, as well as the public cloud networks 106 and 110. Such policies can be coordinated by the multi-site controller 116 with a controller in the on-premises network 102 and the cloud controllers in the public cloud networks 106 and 110, such as cloud controller 114 in the cloud network 106. Thus, while not illustrated in FIGS. 1A and 1B, the public cloud networks 106 and 110 may include VRFs.

As illustrated, the public cloud network 106 may include virtual private clouds (VPCs) 130A, 130B, 130C, and 130N, which represent private networks on the public cloud network 106 and which can be interconnected with the on-premises network 102 and the public cloud network 110 as described herein. The VPCs 130 can host applications and resources on the public cloud network 106 for use by the on-premises network 102.

The VPCs 130A, 130B, 130C, and 130N can include endpoint groups (EPGs) 135 that include multiple end points (not illustrated) on the public cloud network 106. For example, VPC 130A can include EPGs 135A, VPC 130B can include EPGs 135B, and VPC 130N can include EPGs 135N. The EPGs 135 can include virtual/logical and/or physical endpoints, such as VMs, software containers, physical servers, etc.

Traffic to and from the VPCs 130A, 130B, 130C, and 130N can be routed via routers 136, 138, 140, and 142, which can include virtual cloud routers included in the public cloud network 106, and the like. The routers 136, 138, 140, and 142 can serve as the ingress and egress points of the VPCs 130A, 130B, 130C, and 130N, and can interconnect the VPCs 130A, 130B, 130C, and 130N with each other as well as other external devices or networks (e.g., on-premises network 102 and public cloud network 110) through one of gateways 124A-124N.

As noted above, public cloud networks 106 and/or 110 may provide services to users that subscribe for use of their computing resources. As a specific example, AWS may provide the Transit Gateway (TGW) which is a network transit hub, such as a centralized virtual router running on virtual machines, containers, bare-metal, etc. The TGW may act as a hub that interconnects multiple VPCs 130 and controls how traffic is routed for the VPCs 130. Rather than attaching the VPCs 130 to the on-premises network 102 and/or public cloud network 110 using individual VPNs for each VPC 130, the TGW may allow for a single connection from the central gateway to connect on behalf of multiple VPCs 130. Accordingly, the gateways 124A-124N may comprise a TGW, or similar gateway, that is able to connect to multiple VPCs in a hub-and-spoke model to simplify management and reduce operational cost as the on-premises network 102 and public cloud network 110 need only connect to the gateway 124 as opposed to each individual VPC via a VPN.

The public cloud network 106 (and 110) may include one or more routers 118A-118N configured to communicate with the on-premises network 102 and public cloud network 110. The routers 118 may comprise hardware routers, and/or virtual routers including cloud services routers (CSR), such as Cisco CSR1 kV routers, that encapsulate the data packets using VxLAN, or other usable network overlays on Ethernet VPNs (EVPN) (e.g., an EVPN-VXLAN architecture), to carry VRF information in the packet headers for the data packets. In this way, the routers 118 may send and receive data packets including VRF information to and from the on-premises network 102, public cloud network 110, and so forth. In configurations, in order to maintain VRF segregation, each router's 118 infra VPC 120 maintains an access list 126 and a corresponding route map 128, as will be discussed further herein. The access lists 126 and corresponding route maps 128 allow for maintaining VRF segregation in configurations where the router's 118 infra VPC 120 includes an inserted service, e.g., an application load balancer 144, as will be discussed further herein. In configurations, the access lists 126 and route maps 128 are maintained and stored by the routers 118.

Generally, the routers 118A-118N can provide interconnectivity between the public cloud network 106, the on-premises network 102, and the public cloud network 110 through the of routers 118. The routers 118 can include BGP speakers or agents for establishing BGP sessions. In some implementations, the routers 118 support or implement two control plane sessions (e.g., BGP sessions) with every other region (e.g., on-premises network 102 and public cloud network 110) for redundancy and inter-region connectivity. In other implementations, the routers 118 may support or implement more or less control plane sessions for every other region. For example, the routers 118 may support or implement a single control plane session for one or more other network (e.g., on-premises network 102 and/or public cloud network 110) or more than two control plane session for one or more other regions (e.g., on-premises network 102 and/or public cloud network 110).

The routers 118 can include CSR routers, such as Cisco CSR1 kV routers, and can be equipped with sufficient capacity to store and manage all the routes for the public cloud 108. Moreover, the routers can support or implement internal control plane sessions (e.g., BGP sessions) with a cluster 122 of data plane routers or gateways 124, to exchange and manage routing information for the public cloud network 106.

FIG. 1B illustrates a system diagram of an example architecture of the on-premises network 102 in the multi-cloud fabric 100. The on-premises network 102 can be configured according to the specific SDN or datacenter solution implemented by the on-premises network 102, such as Cisco's ACI, which can be implemented and/or managed via one or more controllers, such as controller 155 (e.g., APIC). The controller 155 can manage security policies and interconnectivity for elements in the on-premises network 102, such as switches (e.g., leaf switches, spine switches, etc.), routers (e.g., physical or virtual gateways or routers, etc.), endpoints (e.g., VMs, software containers, virtual appliances, servers, applications, service chains, workloads, etc.), and/or any other element (physical and/or virtual/logical) in the on-premises network 102. For example, the on-premises network 102 can include spine switches 156 and leaf switches 158 configured to provide network connectivity to VMs 160 in the on-premises network 102. In this example, the controller 155 can manage security policies and interconnectivity for traffic processed by the spine switches 156, the leaf switches 158, and the VMs 160.

The controller 155 can configure EPGs 162, 164, 166, and 168, which can be used to manage and implement policies and configurations for groups of endpoints (e.g., VMs 160). EPGs (e.g., 162, 164, 166, and 168) are managed objects that contain endpoints (e.g., VMs, software containers, virtual appliances, servers, applications, service chains, workloads, etc.) that are connected to the network (e.g., on-premises network 102) either directly or indirectly. Each EPG (162, 164, 166, and 168) can include a group of endpoints. For example, EPG 162, 164, 166, and 168 can include VMs 160.

The endpoints (e.g., VMs 160) in the EPGs 162, 164, 166, and 168 can have certain attributes, such as an address, location, identity, prefix, functionality, application service, etc., and can be physical and/or virtual. EPGs are thus logical groupings of such endpoints based on one or more common factors. Non-limiting example factors which can be used to group endpoints into a common EPG to include common security requirements, common VM mobility requirements, common QoS (quality-of-service) settings, common L4-L7 of the OSI model (Layer 4 through Layer 7 of the OSI model) services, etc., EPGs (e.g., 162, 164, 166, and 168) can span multiple switches and can be associated with respective bridge domains (BDs). In some aspects, endpoint membership in an EPG can be static or dynamic.

EPGs 162, 164, 166, and 168 can contain respective endpoint memberships and can represent different EPGs (e.g., logical groupings) that are based on different, respective factors as previously explained. For example, EPG 162 may represent a logical grouping of endpoints (e.g., VMs 160) configured as web servers (e.g., WEB-EPG), EPG 164 may represent a logical grouping of endpoints (e.g., VMs 160) configured as database servers (e.g., DB-EPG), and EPG 166 may represent a logical grouping of endpoints (e.g., VMs 160) configured as specific application servers (e.g., APP.A-EPG). The controller 155 can configure specific policies (e.g., contracts, filters, requirements, etc.) for each of the EPGs 162, 164, 166, and 168. Such policies or contracts can define, for example, what EPGs can communicate with each other and what type of traffic can pass between the EPGs 162, 164, 166, and 168.

The controller 155 can also configure VRF instances (134A, 134B, 134C, and 134N) which provide different address domains that serve as private networks and segregate traffic between the VRFs. The VRFs 136A-N can include various, respective objects such as endpoints (e.g., VMs 160), EPGs (e.g., 162, 164, 166, and 168), etc. For example, EPG 162 can reside in VRF 134A, EPG 164 can reside in VRF 134B, EPG 166 can reside inside VRF 134C, and EPG 168 can reside in VRF 134N.

The controller 155 may work with the MSC 116 to implement the VRFs 134 and associated policies in the on-premises network 102 as well as the public cloud networks 106 and 110. Such policies can be coordinated by the multi-site controller 116 with the controller 155 in the on-premises network 102 and the cloud controllers 114 in the public cloud networks 106 and 110.

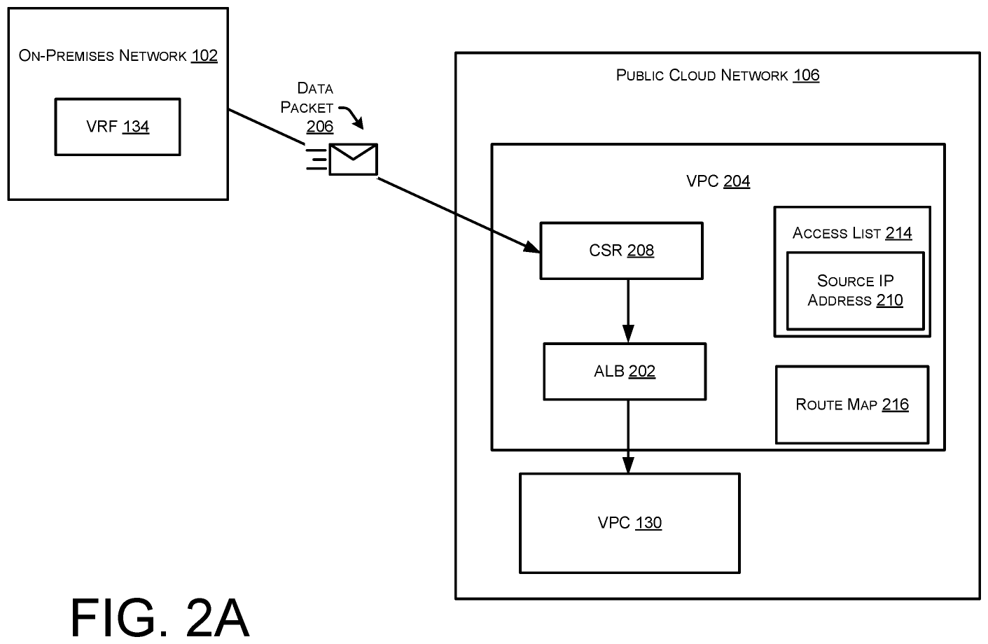

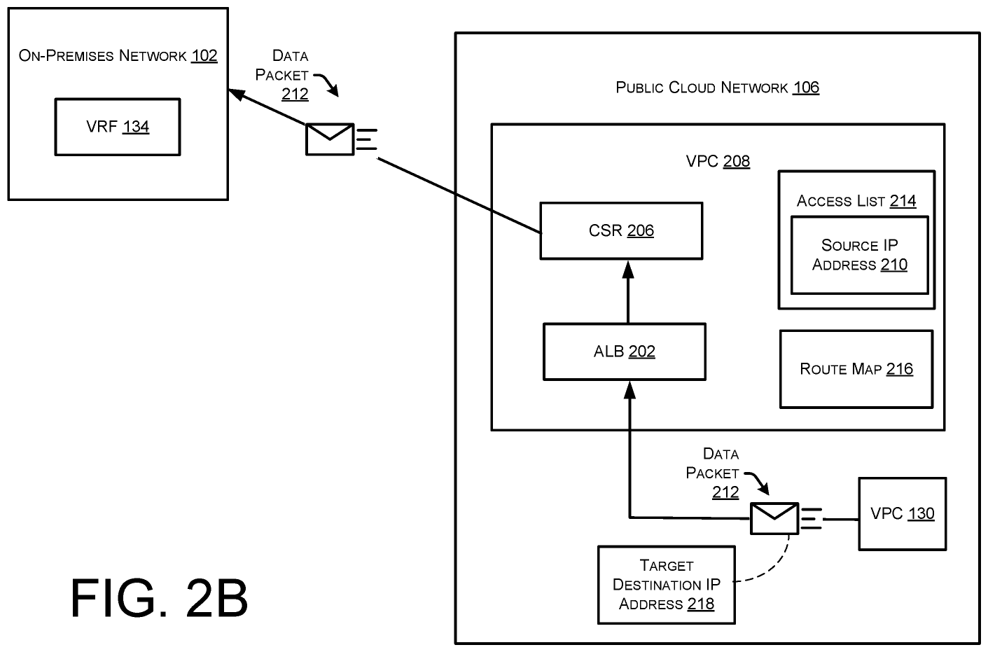

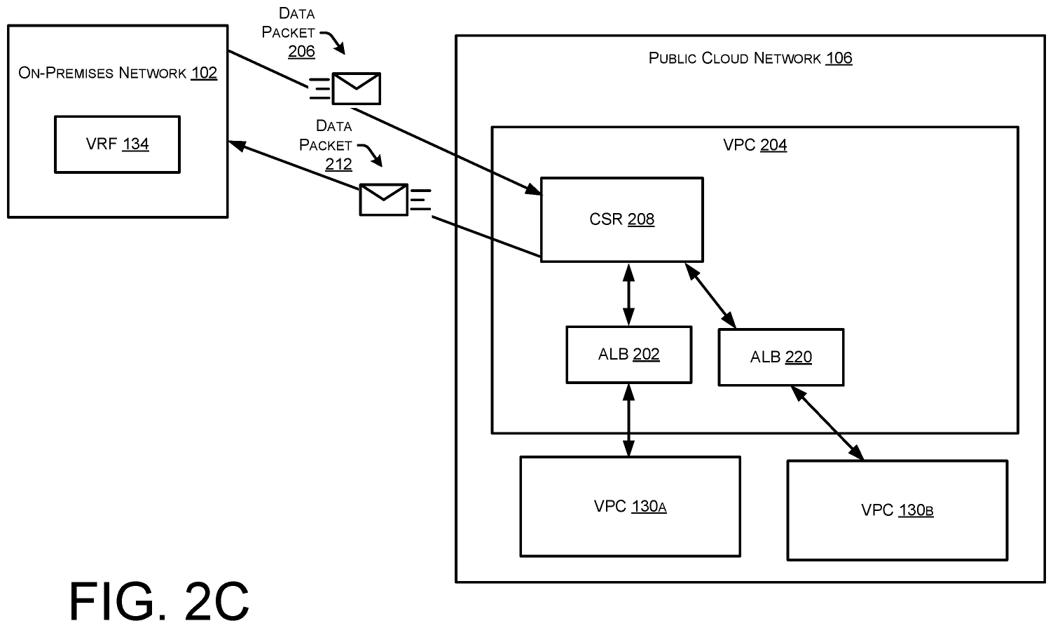

Referring to FIGS. 2A-2C, as previously noted a service, e.g., an application load balancer (ALB) 202 (e.g., ALB 144a, 144b), may be inserted along a path between the on-premises network 102 and one of the public cloud networks 106 and 110, or along a path between the public cloud network 106 and the public cloud network 110. In configurations, the ALB 202 is inserted infra VPC 204 (e.g., infra VPC 120a, 120b) of a public cloud network, e.g., public cloud network 106 and/or public cloud network 110. In the examples of FIGS. 2A-2C, on-premises network 102 and public cloud network 106 are used in the description.

In configurations, when a first data packet 206 is sent from the on-premises network 102 to cloud services router (CSR) 208 infra VPC 204 of the public cloud network 106 with a source IP address 210 corresponding to a sending EPG (e.g., one of EPGs 135) in the on-premises network 102 and a destination IP address for the ALB 202, the ALB 202 is treated as an EPG. The incoming first data packet 206 also includes a target destination IP address for a target destination EPG at a VPC 130 of the public cloud network 106. The first data packet 206 may then be sent from the ALB 202 to the destination EPG via the appropriate TGW (e.g., gateway 124).

However, referring to FIG. 2B, when the first data packet 206 returns from the destination EPG as a second data packet 212 (e.g., the first data packet 206 has been processed) to return to the on-premises network 102, the second data packet 212 is sent with a destination IP address of the ALB 202 and a target destination IP address 218. The ALB 202 re-sources the second data packet 212 based on the network address translation (NAT) rules and puts the target destination IP address 218 on the second data packet 212. The target destination IP address 218 is the same as the source IP address 210. Since the next hop from the ALB 202 is the CSR 208, when the second data packet 212 enters the CSR 208, a mechanism is needed to identify the VRF 134 of the second data packet 212 and perform VxLAN encapsulation with the correct rewrite/target visual networking index (VNI).

Thus, in configurations, when the first data packet 206 is received by the CSR 206, a policy-based routing (PBR) rule is instituted on the CSR 208 to set the appropriate VRF 134 of the incoming first data packet 206 based on the source IP address of the source EPG (address 210). In configurations, the destination IP address of the destination EPG (ALB 202) may also be included. Accordingly, an access list 214 (e.g., access list 126a, 126b) is maintained that lists source IP addresses 210 (and possibly destination IP addresses) of incoming packets from the on-premises network 102. Based on the access list 214, a route map 216 is created and maintained that identifies the VRF 134 based on the source IP address 210 of the incoming data packets 206 and the destination IP address (e.g., the IP address of the ALB 202) at the on-premises network 102. In configurations, the access list 214 and route map 216 are maintained and stored by the CSR 208.

When the CSR 208 receives data packets, e.g., second data packets 212 from the cloud network 106, from the ALB 202 for routing back to the on-premises network 102, the route map 216 may be utilized to identify the appropriate VRF 134 based on the target destination IP address 210 of the second data packets 212, which was the source address 210 of the first data packets 206. Once the VRF 134 of the second data packets 212 is identified, the second data packets 212 may be forwarded to the appropriate EPG at the on-premises network 102 in one of two ways. The second data packets 212 may be forwarded via the VRF 134 using VxLAN encapsulation to automatically route the second data packets 212 from the CSR 208 to an on-premises spine 156 of the on-premises network 102. Without the VxLAN encapsulation, a tunnel interface may be created per VRF 134 between the cloud CSR 208 and an on-premises network IP sect terminating device, from which the second data packets will directly head to the ACI leaf 158 on that particular VRF 134 to the original source EPG 162, 164, 166, or 168, e.g., the destination EPG of the second data packet 212.

Referring to FIG. 2C, a second ALB 220 may be included infra VPC 204. Thus, in configurations, one ALB may be provided per group of non-overlapping subnets, e.g., VPC 130a and VPC 130b. Thus, any time there is an overlap of subnets, another ALB may be spun to service data packets for each group of non-overlapping subnets. Accordingly, ALB 220 may receive a separate interface of the CSR 208 as its next-hop for traffic exiting the public cloud network 106, i.e., every ALB has a unique interface in the CSR 208 as its next-hop in order to uniquely identify the VRF 134 of a second data packet 212 even with subnet overlaps. For example, first data packets 206 destined for VPC 130a are routed by the CSR 208 to ALB 202, while first data packets 206 destined for VPC 130b are routed by the CSR 208 to ALB 220. When corresponding second data packets 212 are sent from VPC 130a, the second data packets 212 are routed to ALB 20, while corresponding second data packets 212 sent from VPC 130b are routed to ALB 220. Based on whether the second data packets 212 are received by the CSR 208 from ALB 202 or ALB 220, the appropriate VRF 134 may be selected for routing to the on-premises network 102. In such configurations, the access list 214 and corresponding route map 216 may not be included.

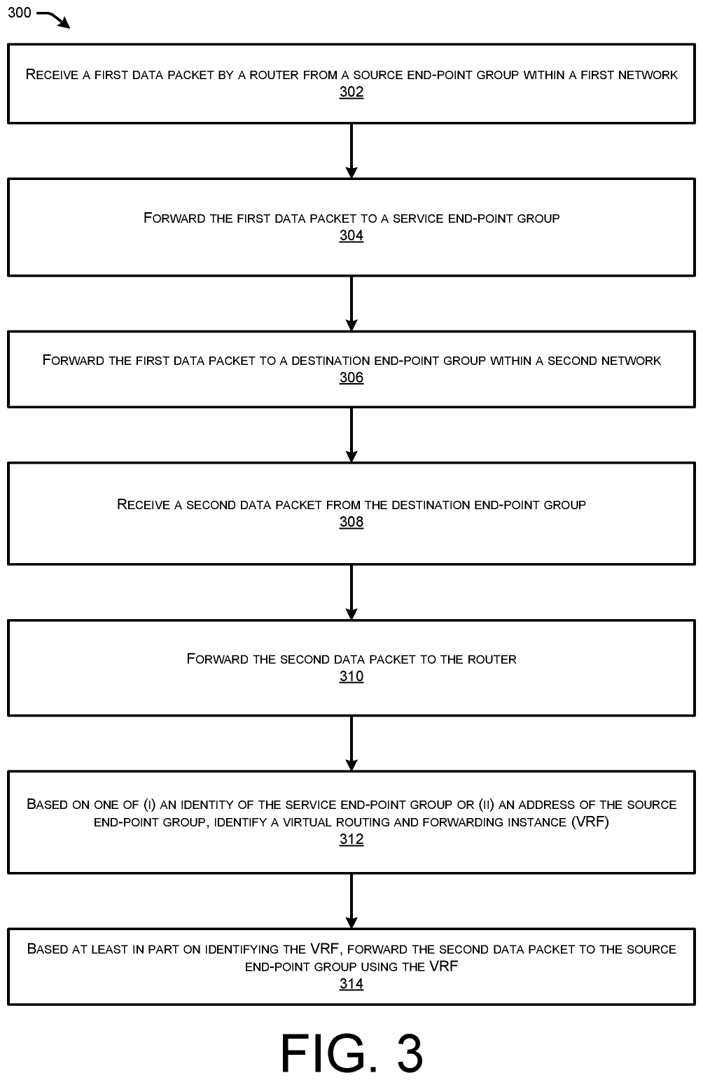

FIG. 3 illustrates a flow diagram of an example method 300 and illustrates aspects of the functions performed at least partly by one or more devices in the multi-cloud fabric 100 as described in FIGS. 1A, 1B, and 2A-2C. The logical operations described herein with respect to FIG. 3 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 3 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 3 illustrates a flow diagram of an example method 300 for maintaining virtual routing and forwarding (VRF) segregation for network paths through multi-cloud fabrics that utilize shared services, e.g., application load balancers (ALBs). In some examples, the method 300 may be performed by a system comprising one or more processors and one or more non-transitory computer-readable media storing computer-executable instructions that, when executed by the one or more processors, cause the one or more processors to perform the method 300.

At 302, a router of a first network of a multi-cloud fabric comprising two or more networks receives a first data packet from a source end-point group within the first network. At 304, the first data packet is forwarded by the router to a service end-point group.

At 306, the first data packet is forwarded by the service end-point group to a destination end-point group within a second network. At 308, the service end-point group receives a second data packet from the destination end-point group. At 310, the second data packet by the service end-point group is forwarded to the router.

At 312, based on one of (i) an identity of the service end-point group or (ii) an address of the source end-point group, a virtual routing and forwarding instance (VRF) is identified. At 314, based at least in part on identifying the VRF, the router forwards the second data packet by the router to the source end-point group using the VRF.

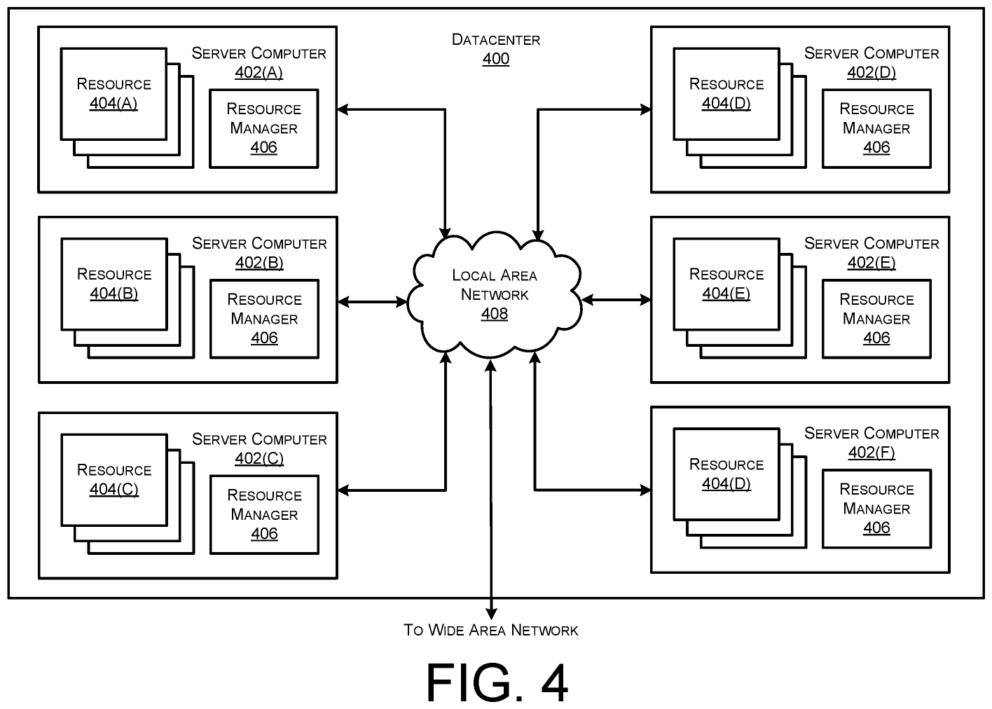

FIG. 4 is a computing system diagram illustrating a configuration for a datacenter 400 that can be utilized to implement aspects of the technologies disclosed herein. The example datacenter 400 shown in FIG. 4 includes several server computers 402A-402F (which might be referred to herein singularly as “a server computer 402” or in the plural as “the server computers 402”) for providing computing resources. In some examples, the resources and/or server computers 402 may include, or correspond to, the EPs 132 and/or EPGs 135, 168 described herein. Similarly, the datacenter 400 may correspond to one or more of the on-premises datacenters 104, the cloud datacenters 108 (site 1), and/or the cloud datacenters 112 (site 2).

The server computers 402 can be standard tower, rack-mount, or blade server computers configured appropriately for providing the computing resources described herein. As mentioned above, the computing resources provided by the cloud computing network 102 can be data processing resources such as VM instances or hardware computing systems, database clusters, computing clusters, storage clusters, data storage resources, database resources, networking resources, and others. Some of the servers 402 can also be configured to execute a resource manager capable of instantiating and/or managing the computing resources. In the case of VM instances, for example, the resource manager can be a hypervisor or another type of program configured to enable the execution of multiple VM instances on a single server computer 402. Server computers 402 in the datacenter 400 can also be configured to provide network services and other types of services.

In the example datacenter 400 shown in FIG. 4, an appropriate LAN 408 is also utilized to interconnect the server computers 402A-402F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between datacenters 400, between each of the server computers 402A-402F in each datacenter 400, and, potentially, between computing resources in each of the server computers 402. It should be appreciated that the configuration of the datacenter 400 described with reference to FIG. 4 is merely illustrative and that other implementations can be utilized.

In some examples, the server computers 402 may each execute one or more virtual resources that support a service or application provisioned across a set or cluster of servers 402. The virtual resources on each server computer 402 may support a single application or service, or multiple applications or services (for one or more users).

In some instances, the cloud computing networks 106 and 110 may provide computing resources, like application containers, VM instances, and storage, on a permanent or an as-needed basis. Among other types of functionality, the computing resources provided by cloud computing networks may be utilized to implement the various services described above. The computing resources provided by the cloud computing networks can include various types of computing resources, such as data processing resources like application containers and VM instances, data storage resources, networking resources, data communication resources, network services, and the like.

Each type of computing resource provided by the cloud computing networks can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing networks can also be configured to provide other types of computing resources not mentioned specifically herein.

The computing resources provided by the cloud computing networks may be enabled in one embodiment by one or more datacenters 400 (which might be referred to herein singularly as “a datacenter 400” or in the plural as “the datacenters 400”). The datacenters 400 are facilities utilized to house and operate computer systems and associated components. The datacenters 400 typically include redundant and backup power, communications, cooling, and security systems. The datacenters 400 can also be located in geographically disparate locations. One illustrative embodiment for a datacenter 400 that can be utilized to implement the technologies disclosed herein will be described below with regard to FIG. 4.

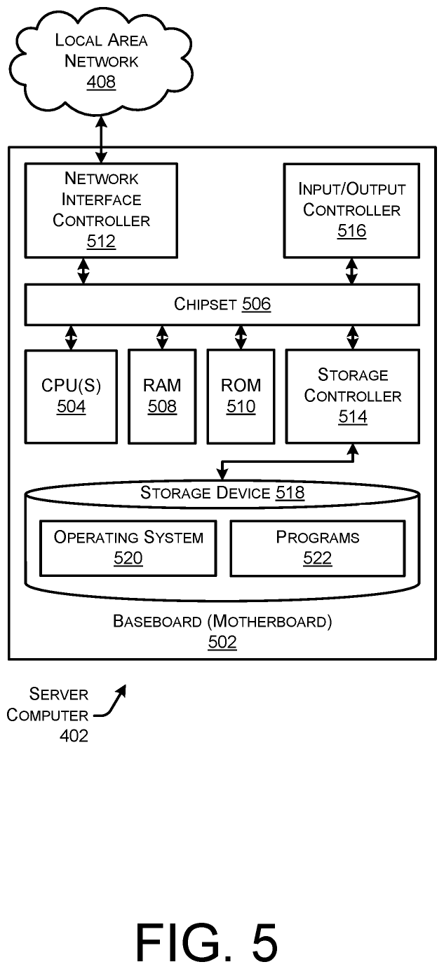

FIG. 5 shows an example computer architecture for a server computer 402 capable of executing program components for implementing the functionality described above. The computer architecture shown in FIG. 5 illustrates a conventional server computer, workstation, desktop computer, laptop, tablet, network appliance, e-reader, smartphone, or other computing device, and can be utilized to execute any of the software components presented herein. The server computer 402 may, in some examples, correspond to a physical devices or resources described herein.

The server computer 402 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the server computer 402.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the server computer 402. The chipset 506 can further provide an interface to a computer-readable storage medium such as a read-only memory (“ROM”) 510 or non-volatile RAM (“NVRAM”) for storing basic routines that help to startup the server computer 402 and to transfer information between the various components and devices. The ROM 510 or NVRAM can also store other software components necessary for the operation of the server computer 402 in accordance with the configurations described herein.

The server computer 402 can operate in a networked environment using logical connections to remote computing devices and computer systems through a network, such as the network 408. The chipset 506 can include functionality for providing network connectivity through a NIC 512, such as a gigabit Ethernet adapter. The NIC 512 is capable of connecting the server computer 402 to other computing devices over the network 408. It should be appreciated that multiple NICs 512 can be present in the server computer 402, connecting the computer to other types of networks and remote computer systems.

The server computer 402 can be connected to a storage device 518 that provides non-volatile storage for the computer. The storage device 518 can store an operating system 520, programs 522, and data, which have been described in greater detail herein. The storage device 518 can be connected to the server computer 402 through a storage controller 514 connected to the chipset 506. The storage device 518 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server computer 402 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like.

For example, the server computer 402 can store information to the storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server computer 402 can further read information from the storage device 518 by detecting the physical states or characteristics of one or more particular locations within the physical storage units.

In addition to the mass storage device 518 described above, the server computer 402 can have access to other computer-readable storage media to store and retrieve information, such as program modules, data structures, or other data. It should be appreciated by those skilled in the art that computer-readable storage media is any available media that provides for the non-transitory storage of data and that can be accessed by the server computer 402. In some examples, the operations performed by the cloud computing network, and or any components included therein, may be supported by one or more devices similar to server computer 402. Stated otherwise, some or all of the operations performed by the cloud computing network 102, and or any components included therein, may be performed by one or more computer devices 402 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 518 can store an operating system 520 utilized to control the operation of the server computer 402. According to one embodiment, the operating system comprises the LINUX operating system. According to another embodiment, the operating system comprises the WINDOWS® SERVER operating system from MICROSOFT Corporation of Redmond, Wash. According to further embodiments, the operating system can comprise the UNIX operating system or one of its variants. It should be appreciated that other operating systems can also be utilized. The storage device 518 can store other system or application programs and data utilized by the server computer 402.

In one embodiment, the storage device 518 or other computer-readable storage media is encoded with computer-executable instructions which, when loaded into the server computer 402, transform the computer from a general-purpose computing system into a special-purpose computer capable of implementing the embodiments described herein. These computer-executable instructions transform the server computer 402 by specifying how the CPUs 504 transition between states, as described above. According to one embodiment, the computer 402 has access to computer-readable storage media storing computer-executable instructions which, when executed by the computer 402, perform the various processes described above with regard to FIGS. 1-4. The computer 402 can also include computer-readable storage media having instructions stored thereupon for performing any of the other computer-implemented operations described herein.

The server computer 402 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device. It will be appreciated that the server computer 402 might not include all of the components shown in FIG. 5, can include other components that are not explicitly shown in FIG. 5, or might utilize an architecture completely different than that shown in FIG. 5.

The server computer 402 may support a virtualization layer, such as one or more virtual resources executing on the server computer 402. In some examples, the virtualization layer may be supported by a hypervisor that provides one or more virtual machines running on the server computer 402 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a router of a first network of a multi-cloud fabric comprising two or more networks, a first data packet from a source end-point group within the first network;
forwarding the first data packet by the router to a service end-point group;
forwarding the first data packet by the service end-point group to a destination end-point group within a second network;
receiving, at the service end-point group, a second data packet from the destination end-point group;
forwarding the second data packet by the service end-point group to the router;
based on one of (i) an identity of the service end-point group or (ii) an address of the source end-point group, identifying a virtual routing and forwarding instance (VRF); and
based at least in part on identifying the VRF, forwarding the second data packet by the router to the source end-point group using the VRF.

2. The method of claim 1, wherein forwarding the second data packet by the router to the source end-point group comprises:
upon receipt at the router of the first data packet from the source end-point group, creating an access list matching the address of the source end-point group and the address of the destination end-point group;
based on the access list matching the address of the source end-point group and the address of the destination end-point group, creating a route map identifying the VRF;
upon receipt at the router of the second data packet from the service end-point group, based at least in part on the address of the source end-point group, matching, by the router, the address of the source end-point group in the access list;
based at least in part on the matching the address of the source end-point group in the access list, identifying the VRF; and
based at least in part on identifying the VRF, forwarding the second data packet by the router to the source end-point group using the VRF.

3. The method of claim 2, wherein forwarding the second data packet by the router to the source end-point group using the VRF comprises:
automatically forwarding the second data packet by the router to the source end-point group based on virtual extensible local access network (VxLAN) encapsulation.

4. The method of claim 3, wherein the first network is a cloud network and the second network is an on-premises network.

5. The method of claim 2, wherein forwarding the second data packet by the router to the source end-point group using the VRF comprises:
creating a tunnel interface between the first network and the second network;
forwarding, from the router via the tunnel interface, the second data packet to the second network; and
forwarding the second data packet within the second network to the source end-point group using the VRF.

6. The method of claim 5, wherein the first network is a cloud network and the second network is an on-premises network.

7. The method of claim 1, wherein the service end-point group is a first service end-point group and the method further comprises:
providing a second service end-point group,
wherein identifying the VRF comprises identifying the VRF based on whether the router receives the second data packet from the first service end-point group or the second service end-point group.

8. A system comprising:
one or more processors; and
one or more non-transitory computer-readable media storing computer-executable instructions that, when executed by the one or more processors, cause the one or more processors to:
receive, at a router, a first data packet from a source end-point group within a first network;
forward the first data packet by the router to a service end-point group;
forward the first data packet by the service end-point group to a destination end-point group within a second network;
receive, at the service end-point group, a second data packet from the destination end-point group;
forward the second data packet by the service end-point group to the router;
based on one of (i) an identity of the service end-point group or (ii) an address of the source end-point group, identifying a virtual routing and forwarding instance (VRF); and
based at least in part on identifying the VRF, forwarding the second data packet by the router to the source end-point group using the VRF.

9. The system of claim 8, wherein forward the second data packet by the router to the source end-point group comprises:
upon receipt at the router of the first data packet from the source end-point group, creating an access list matching an address of the source end-point group and the address of the destination end-point group;
based on the access list matching the address of the source end-point group and the address of the destination end-point group, creating a route map identifying the VRF;
upon receipt at the router of the second data packet from the service end-point group, based at least in part on the address of the source end-point group, matching, by the router, the address of the source end-point group in the access list;
based at least in part on the matching the address of the source end-point group in the access list, identifying the VRF; and
based at least in part on identifying the VRF, forwarding the second data packet by the router to the source end-point group using the VRF.

10. The system of claim 9, wherein forward the second data packet by the router to the source end-point group using the VRF comprises:
automatically forwarding the second data packet by the router to the source end-point group based on virtual extensible local access network (VxLAN) encapsulation.

11. The system of claim 10, wherein the first network is a cloud network and the second network is an on-premises network.

12. The system of claim 9, wherein forward the second data packet by the router to the source end-point group using the VRF comprises:
creating a tunnel interface between the first network and the second network;
forwarding, from the router via the tunnel interface, the second data packet to the second network; and
forwarding the second data packet within the second network to the source end-point group using the VRF.

13. The system of claim 12, wherein the first network is a cloud network and the second network is an on-premises network.

14. The system of claim 8, wherein the service end-point group is a first service end-point group and the computer-executable instructions, when executed by the one or more processors, cause the one or more processors to:
provide a second service end-point group,
wherein identifying the VRF comprises identifying the VRF based on whether the router receives the second data packet from the first service end-point group or the second service end-point group.

15. One or more non-transitory computer-readable media storing computer-executable instructions that, when executed by one or more processors, cause the one or more processors to:
receive, at a router, a first data packet from a source end-point group within a first network;
forward the first data packet by the router to a service end-point group;
forward the first data packet by the service end-point group to a destination end-point group within a second network;
receive, at the service end-point group, a second data packet from the destination end-point group;
forward the second data packet by the service end-point group to the router;
based on one of (i) an identity of the service end-point group or (ii) an address of the source end-point group, identifying a virtual routing and forwarding instance (VRF); and
based at least in part on identifying the VRF, forwarding the second data packet by the router to the source end-point group using the VRF.

16. The one or more non-transitory computer-readable media of claim 15, wherein forwarding the second data packet by the router to the source end-point group comprises:
upon receipt at the router of the first data packet from the source end-point group, creating an access list matching the address of the source end-point group and the address of the destination end-point group;
based on the access list matching the address of the source end-point group and the address of the destination end-point group, creating a route map identifying the VRF;
upon receipt at the router of the second data packet from the service end-point group, based at least in part on the address of the source end-point group, matching, by the router, the address of the source end-point group in the access list;
based at least in part on the matching the address of the source end-point group in the access list, identifying the VRF; and
based at least in part on identifying the VRF, forwarding the second data packet by the router to the source end-point group using the VRF.

17. The one or more non-transitory computer-readable media of claim 16, wherein forwarding the second data packet by the router to the source end-point group using the VRF comprises:
automatically forwarding the second data packet by the router to the source end-point group based on virtual extensible local access network (VxLAN) encapsulation.

18. The one or more non-transitory computer-readable media of claim 17, wherein the first network is a cloud network and the second network is an on-premises network.

19. The one or more non-transitory computer-readable media of claim 16, wherein forwarding the second data packet by the router to the source end-point group using the VRF comprises:
creating a tunnel interface between the first network and a second network of the two or more networks;
forwarding, from the router via the tunnel interface, the second data packet to the second network; and
forwarding the second data packet within the second network to the source end-point group using the VRF.

20. The one or more non-transitory computer-readable media of claim 15, wherein the service end-point group is a first service end-point group and the computer-executable instructions, when executed by the one or more processors, cause the one or more processors to:
provide a second service end-point group,
wherein identifying the VRF comprises identifying the VRF based on whether the router receives the second data packet from the first service end-point group or the second service end-point group.
